(19) United States
(12) Patent Application Publication
(10) Pub. No.: US 2025/0294108 A1
(43) Pub. Date: Sep. 18, 2025

(54) MACHINE LEARNING SYSTEM, MACHINE LEARNING METHOD, AND STORAGE MEDIUM

(71) Applicant: CANON KABUSHIKI KAISHA, Tokyo (JP)

(72) Inventor: Kenji KURIBAYASHI, Kanagawa (JP)

(21) Appl. No.: 19/070,605

(22) Filed: Mar. 5, 2025

(30) Foreign Application Priority Data
Mar. 15, 2024 (JP) 2024-041590

(51) Int. Cl. H04N 1/409; G06N 20/00

(52) U.S. Cl. CPC H04N 1/409; G06N 20/00

(57) ABSTRACT

A training unit is configured to perform training of the learning model for estimating corrective action content from a type of fault for each type of apparatus based on the data of corrective action for the fault. The training unit is configured to: perform training of the learning model for estimating the corrective action content from the type of fault for an apparatus of a first type. This training uses, as learning data, data of corrective action for the fault of the apparatus of the first type, and data of corrective action for the fault related to a common constituent component of an apparatus of a different type that shares the common constituent component with the fault component of the apparatus of the first type.

### BACKGROUND OF THE INVENTION

### Field of the Invention

The present invention relates to a machine learning system, a machine learning method, and a storage medium.

### Description of the Related Art

In a known case where an anomaly such as an error or a fault of an apparatus occurs, a maintenance person such as a service man is dispatched by notification of the anomaly. The maintenance person checks the manual and performs maintenance such as component replacement.

In recent years, cloud computing has been spreading. A main feature of cloud computing is that data conversion and data processing are executed in a distributed manner by using many computing resources, and requests from many clients are processed in parallel by distributed parallel processing. Use of cloud computing allows a system developer to easily procure necessary computing resources and to focus on system function development.

One of the elements having high affinity with cloud computing is artificial intelligence (AI). Core technologies implementing AI include machine learning. In machine learning, it is possible to create a learning model in which a feature (characteristic, pattern, tendency, and the like) of data is extracted by analyzing a large amount of data (big data) with a learning algorithm. Many computing resources are required to securely store and analyze such a large amount of data, and thus often introduced in a cloud computing environment.

In general, in machine learning, a learning model is trained using learning data, and a learning model of which training has been competed is actually operated as a trained model. The learning data for training the learning model is essential for construction of a trained model, but in practice, it is also assumed to take a huge amount of time to collect defect information depending on the type of defect.

Japanese Patent Laid-Open No. 2021-177319 proposes a learning model for predicting occurrence of a defect based on one or more sensor detection results of a home appliance. The proposed learning model includes a trained model generated for each major classification of the basic form of the home appliance and a trained model generated for each minor classification for each model, and performs fault diagnosis of the home appliance using two trained models. This enables more learning data to be obtained in each major classification of the basic form even when sufficient learning data cannot be obtained in the minor classification for each model, and therefore prediction accuracy can be improved.

However, with the proposed learning model, it is assumed that the generated trained model cannot be applied in a case where the apparatus configuration is different even if the basic form of the home appliance is the same. A situation in which it takes a huge amount of time to collect information regarding a specific defect and sufficient learning data cannot be obtained is not improved.

### SUMMARY OF THE INVENTION

The present invention enables realization of a technique of selecting collected learning data based on apparatus configuration information and efficiently using the collected learning data.

One aspect of the present invention provides a machine learning system for training a learning model, comprising: a processor configured to execute a training algorithm using training data; a memory storing data of corrective action for a fault and a learning model, wherein the data of corrective action for the fault includes a type of fault for each type of apparatus, a constituent component of the apparatus that has caused the fault, and corrective action content for the fault, and a training unit configured to perform training of the learning model for estimating corrective action content from a type of fault for each type of the apparatus based on the data of corrective action for the fault, wherein the training unit is configured to perform training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.

Another aspect of the present invention provides a machine learning method, the method comprising: providing data of corrective action for a fault, wherein the data of corrective action for the fault includes a type of fault for each type of apparatus, a constituent component of the apparatus that has caused the fault, and corrective action content for the fault; and performing training of the learning model for estimating corrective action content from a type of fault for each type of the apparatus based on the data of corrective action for the fault, wherein the training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.

Still another aspect of the present invention provides a non-transitory computer-readable storage medium storing data of corrective action for a fault, one or more learning models, and one or more programs, wherein the data of corrective action for the fault includes a type of fault for each type of apparatus, a constituent component of the apparatus that has caused the fault, and corrective action content for the fault, the programs are configured to cause a computer to execute each step of a machine learning method, the method comprising: performing training of the learning model for estimating corrective action content from a type of fault for each type of the apparatus based on the data of corrective action for the fault, wherein the training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.

Further features of the present invention will be apparent from the following description of exemplary embodiments with reference to the attached drawings.

### BRIEF DESCRIPTION OF THE DRAWINGS

FIG. 1 is a configuration diagram of a machine learning system according to the present invention.

FIGS. 2A and 2B are hardware configuration diagrams of the machine learning system according to the present invention.

FIG. 3 is a sequence diagram of fault diagnosis processing in one example.

FIGS. 4A and 4B are examples of scan image including an anomaly in one example.

FIG. 5 is an example of a screen of an input device.

FIG. 6 is a software configuration diagram of a fault diagnosis result notification server in one example.

FIG. 7A is a flowchart of overall processing of the fault diagnosis result notification server in one example.

FIG. 7B is a flowchart of learning data collection processing of the fault diagnosis result notification server in one example.

FIG. 8 is a flowchart of machine learning processing in one example.

FIGS. 9A and 9B are cross-sectional views of an image forming apparatus in one example.

FIG. 10 is a block diagram illustrating a configuration of an electric system in one example.

FIGS. 11A, 11B, and 11C are apparatus constituent component lists and a diagnosis target model series list in one example.

FIGS. 12A and 12B together form a single flowchart of machine learning processing in one example.

FIG. 13 is an apparatus constituent component list in one example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

Hereinafter, data generated by the present proposal in order to generate a machine learning model is called learning data, and data to be input to a trained model and estimated is called input data. Data for retraining a created machine learning model is also called learning data, and learning includes retraining. Performing training of a learning model with learning data includes creating the learning model with the learning data and retraining the learning model with the learning data.

A machine learning system of the present embodiment collects learning data including a fault component and repair content corresponding to a defect of an apparatus, creates a machine learning model using learning data, receives a notification of the defect of the apparatus using the created learning model, and estimates corrective action content.

The user performing the corrective action may be a maintenance person performing the service, or may be a user of the apparatus. Replacement of consumables and the like may be performed not only by the maintenance person but also by the user of the apparatus.

The machine learning system of the present embodiment is configured to include a fault diagnosis result notification server 104. Fault diagnosis apparatuses may further include an apparatus defect information collection server 102, a replacement component information collection server 105, and an operation information collection server 106. The apparatus defect information collection server 102, the fault diagnosis result notification server 104, the replacement component information collection server 105, and the operation information collection server 106 may have any configuration, and may be configured by one or may be configured in a distributed manner. The estimation result of the fault by the fault diagnosis result notification server 104 is displayed on a Web based user interface (Web UI) of a portal site of an input device 103. The user such as a maintenance person views this estimation result and uses it as a reference of the maintenance work content.

### System Configuration

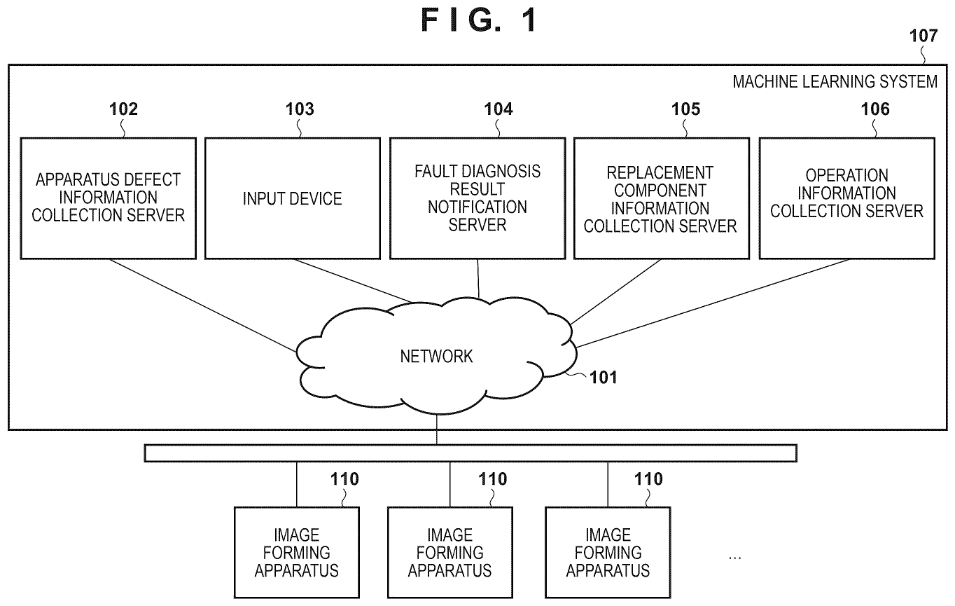

The configuration of a fault diagnosis system that provides a fault diagnosis service online for carrying out the present invention will be described with reference to FIG. 1. The fault diagnosis system of the present invention includes the apparatus defect information collection server 102, the input device 103, the fault diagnosis result notification server 104, the replacement component information collection server 105, the operation information collection server 106, an image forming apparatus 110, and a network 101.

A plurality of the image forming apparatuses 110 are, for example, a digital multifunction peripheral, a facsimile machine, a laser beam printer, a scanner device, or the like. In the present embodiment, the image forming apparatus 110 is a detection target in which a defect is detected in a case where the defect occurs in the image forming apparatus 110 as a predetermined event. Note that the predetermined apparatus applied as a detection target is not limited to the image forming apparatus 110, and may be, for example, another information processing apparatus such as a personal computer or a mobile terminal. The predetermined event is not limited to a defect, and may be, for example, a command to the apparatus.

The apparatus defect information collection server 102 is a server that collects information from the image forming apparatus 110. Defect history information such as an error or a paper jam and image anomaly information related to an image anomaly included in an image are collected and accumulated from the plurality of image forming apparatuses 110 via the network 101.

The replacement component information collection server 105 stores information on a replacement component replaced by the user through maintenance work. The information on the replacement component may be acquired from the image forming apparatus 110 or may be input by the user.

The input device 103 is an input device used by the user. The user inputs actually performed response content from the input device 103, and transmits the response content to the fault diagnosis result notification server 104 via the network 101.

The fault diagnosis result notification server 104 is a server that creates and accumulates learning data and performs diagnosis based on the defect information and the response content of the user. The fault diagnosis result notification server 104 receives various types of information via the network 101. The various types of information include feedback information transmitted by the input device 103, fault history information held by the apparatus defect information collection server 102, and information on a replacement component held by the replacement component information collection server 105. Learning data is created and accumulated based on the various types of received information.

The replacement component information collection server 105 receives the replacement component information transmitted by the input device 103 via the network 101, and collects and accumulates the acquired information. The replacement component information may be acquired from the image forming apparatus 110.

The operation information collection server 106 receives, via the network 101, information at the time of operation of the image forming apparatus 110 such as sensor data transmitted by the plurality of image forming apparatuses 110, and collects and accumulates the information as operation information.

Hereinafter, as an example, the apparatus defect information collection server 102, the fault diagnosis result notification server 104, the replacement component information collection server 105, and the operation information collection server 106 will be described as separate servers. The servers 102, 104, 105, and 106 may be configured by one server, or may be configured by a plurality of servers by distributing the functions of the servers 102, 104, 105, and 106. The configuration of the server is not limited to the form of FIG. 1.

### Hardware Configuration of Image Forming Apparatus 110

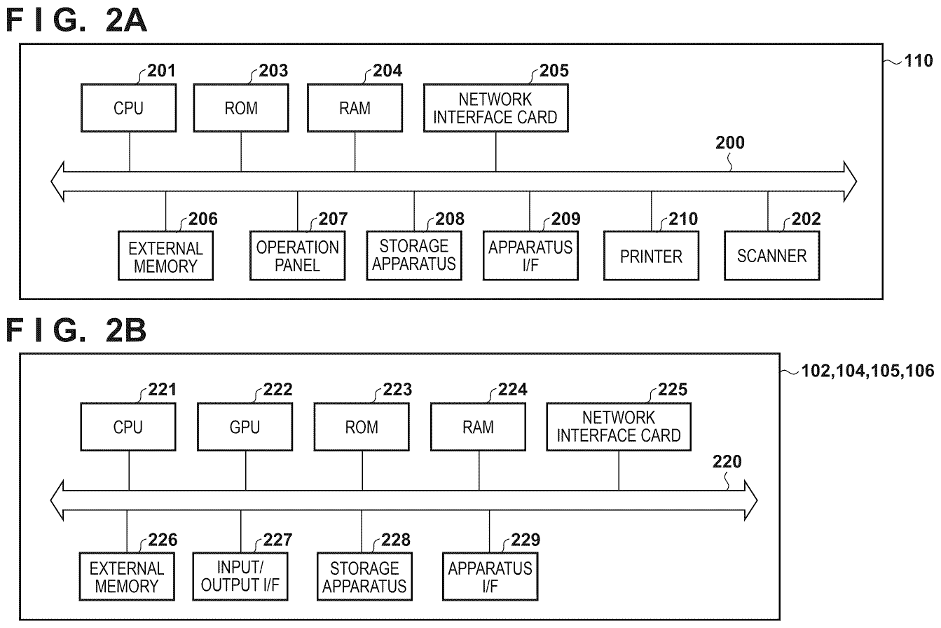

The hardware configuration of the image forming apparatus 110 according to an embodiment of the present invention will be described with reference to FIG. 2A. The image forming apparatus 110 includes a CPU 201, a ROM 203, a RAM 204, a network interface card 205, an external memory 206, an operation panel 207, a storage apparatus 208, an apparatus interface 209, a printer 210, and a scanner 202. Respective constituent elements are connected by a system bus 200.

The CPU 201 integrally controls access to various devices connected to the system bus 200. The CPU 201 performs control by reading, into the RAM 204, and executing a control program or the like stored in the ROM 203 or a control program, resource data (resource information), or the like stored in the external memory 206 connected via a disk controller or the like.

The ROM 203 stores various data such as programs such as a basic I/O program, font data used in document processing, and template data. The RAM 204 functions as a main memory, a work area, and the like of the CPU 201, and is configured such that the memory capacity can be expanded by an optional RAM connected to an expansion port not illustrated.

The network interface card 205 is an interface with an external apparatus, and the image forming apparatus 110 exchanges data with the external apparatus via the network interface card 205. The operation panel 207 displays a screen and receives a user operation instruction via the screen. A display portion such as a button and a liquid crystal panel for performing operations such as setting of an operation mode or the like of a printing apparatus, display of an operation status of the printing apparatus, and copy designation is also arranged.

The storage apparatus 208 is an external storage unit that functions as a large-capacity memory. The apparatus interface 209 is a connection interface with an external apparatus connectable by a USB or the like. The printer 210 uses a known printing technique, and suitable systems include an electrophotographic system (laser beam system), an inkjet system, and a sublimation (thermal transfer) system. As print data, the printer 210 prints, onto paper, image data converted from a page description language (PDL), a portable document format (PDF), or the like.

The scanner 202 uses a known image reading technique, and optically scans a paper document placed on a transparent top plate and converts the paper document into an image. A plurality of paper documents placed on an automatic document feeder (ADF) is continuously read and converted into an image.

### Hardware Configuration of Each Server

The hardware configurations of the apparatus defect information collection server 102, the fault diagnosis result notification server 104, the replacement component information collection server 105, and the operation information collection server 106 according to the embodiment of the present invention will be described with reference to FIG. 2B. The hardware configurations of the servers 102, 104, 105, and 106 are basically the same.

The servers 102, 104, and 105 include a CPU 221, a GPU 222, a ROM 223, a RAM 224, a network interface card 225, an external memory 226, an input/output interface 227, a storage apparatus 228, and an apparatus interface 229. Respective constituent elements are connected by a system bus 220.

The CPU 221 controls the entire apparatus and integrally controls access to various devices connected to the system bus 220. The CPU 221 performs control by reading, into the RAM 224, and executing a control program or the like stored in the ROM 223 or a control program, resource data (resource information), or the like stored in the external memory 226 connected via a disk controller or the like. The GPU 222 is a computing apparatus specialized for vector computation such as image processing and machine learning.

The ROM 223 is a storage unit, and stores various data such as a basic I/O program. The RAM 224 is a RAM that functions as a main memory, a work area, or the like of the CPU 221 and the GPU 222, and is configured such that the memory capacity can be expanded by an optional RAM connected to an expansion port not illustrated.

The network interface card 225 is an interface with an external apparatus, and the server exchanges data with the external apparatus via the network interface card 225.

The input/output interface 227 can display a screen and receive a user operation instruction via an apparatus such as a display, a keyboard, a mouse, a smartphone, and a tablet.

The storage apparatus 228 is an external storage unit that functions as a large-capacity memory.

The apparatus interface 229 is a connection interface with an external apparatus connectable by a USB or the like.

### Cross-Sectional View of Image Forming Apparatus 110

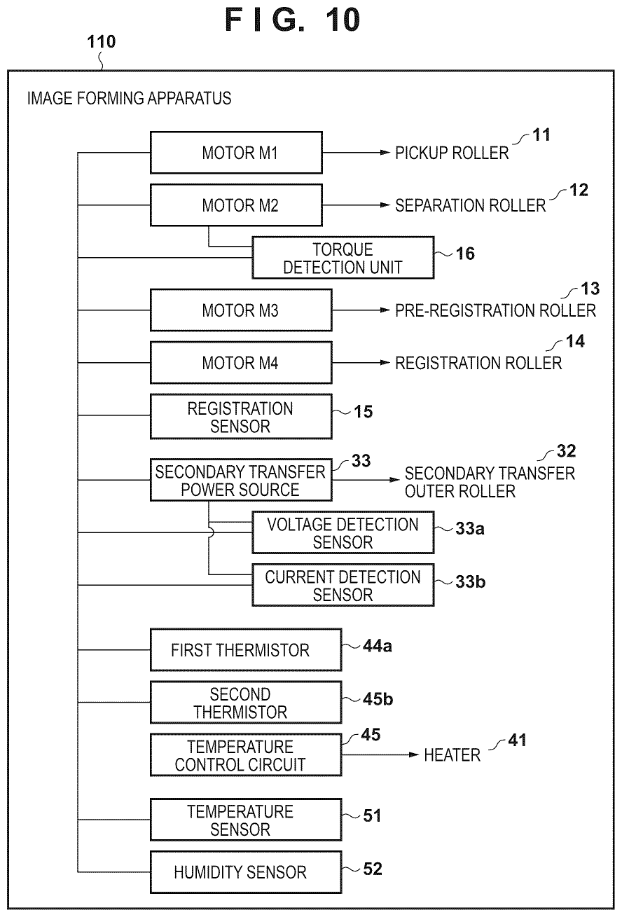

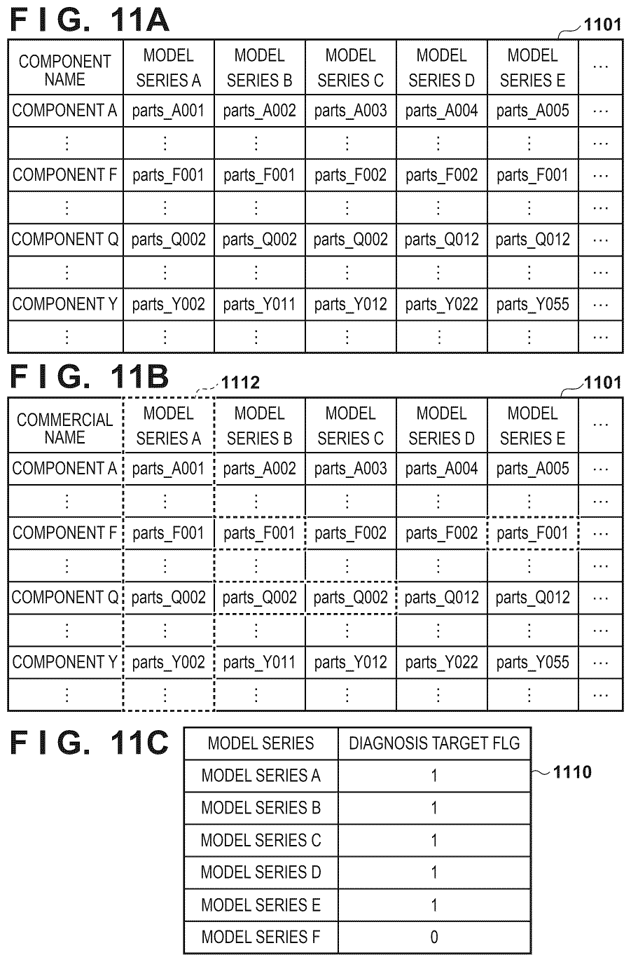

FIG. 9A is a cross-sectional view of the image forming apparatus 110 according to the embodiment of the present invention. An operation of forming an image on a recording material P will be described with reference to FIG. 9A. The image forming apparatus 110 forms an image by an electrophotographic system and adopts what is called a tandem method. FIG. 10 is a block diagram illustrating the configuration of an electric system in the present embodiment.

A drum cartridge that forms toner images of four colors of yellow (Y), magenta (M), cyan (C), and black (K) is provided as a drum cartridge. In the following description, those with only numerals and without reference signs of Y, M, C, and K are parts common to the drum cartridges of the four colors in FIG. 9A.

The image forming apparatus 110 includes one or more sheet feeding cassettes 10. A pickup roller 11 picks up and feeds, to a conveyance path, the recording material P accommodated in the sheet feeding cassette 10. A separation roller 12 is a conveyance roller that separates and conveys, to a further downstream side, only the uppermost one of the recording materials P when the plurality of recording materials P are taken out. A pre-registration roller 13 provided on the downstream side of the separation roller 12 is a conveyance roller that conveys the recording material P to a further downstream side. The register is an abbreviation of registration.

A registration roller 14 provided on the downstream side of the pre-registration roller 13 is a conveyance roller that conveys the recording material P to a further downstream side. A motor M1 is connected to the pickup roller 11, a motor M2 is connected to the separation roller 12, a motor M3 is connected to the pre-registration roller 13, and a motor M4 is connected to the registration roller 14. The rollers are driven by the respective motors. In the present embodiment, the motors M1 to M4 are brushless DC motors.

A torque detection unit 16 is connected to the motor M2, and measures the driving torque of the separation roller 12.

A registration sensor 15 provided on the downstream side of the registration roller 14 outputs a signal indicating that the recording material P is passing in a period from when a leading end of the recording material P is detected to when a trailing end is detected. Note that the conveyance time from when driving of the pickup roller 11 is instructed to when the registration sensor 15 detects the leading end of the recording material P is monitored in order to detect a conveyance delay or a jam.

Image formation by this image forming apparatus 110 is performed as follows. First, the surface of a photosensitive drum 21 is uniformly charged by a charger 22. By exposing this charged surface with a laser 23, an electrostatic latent image is formed on the photosensitive drum 21. Toner is attached from a developer 24 to the thus obtained electrostatic latent image, whereby the electrostatic latent image is developed as a toner image. This toner image is transferred onto an intermediate transfer belt 26 by a primary transfer roller 25.

In parallel with the toner image forming operation, the recording materials P are conveyed from the sheet feeding cassette 10 one by one to the registration roller 14 through the conveyance path. The registration roller 14 corrects skew feeding of the recording material P. After the skew feeding is corrected, the recording material P is conveyed to a secondary transfer portion by the registration roller 14. The toner image of the plurality of colors superimposed and transferred on the intermediate transfer belt 26 is transferred to the conveyed recording material P at the secondary transfer portion where a secondary transfer inner roller 31 and a secondary transfer outer roller 32 abut on each other. The toner image on this recording material P is heated, pressurized, and fixed by a fixing apparatus 4, and then discharged to the outside of the image forming apparatus 110.

### Secondary Transfer Portion Configuration

The secondary transfer portion includes the secondary transfer inner roller 31 and the secondary transfer outer roller 32. The secondary transfer inner roller 31 is disposed to face the secondary transfer outer roller 32 via the intermediate transfer belt 26. A secondary transfer power source 33 is connected to the secondary transfer outer roller 32. A voltage detection sensor 33a that detects an output voltage and a current detection sensor 33b that detects an output current are connected to the secondary transfer power source 33.

The secondary transfer power source 33 applies a direct-current voltage as a secondary transfer voltage to the secondary transfer outer roller 32. The secondary transfer outer roller 32 abuts on the intermediate transfer belt 26 to form the secondary transfer portion with the intermediate transfer belt 26. Due to the secondary transfer portion being applied with a secondary transfer voltage having a polarity opposite to that of the toner, the secondary transfer outer roller 32 secondarily transfers the toner image on the intermediate transfer belt 26 to the recording material P supplied to the secondary transfer portion. The cored bar of the secondary transfer inner roller 31 is connected to the ground potential.

### Configuration of Fixing Apparatus

FIG. 9B illustrates a cross-sectional configuration of the fixing apparatus 4. The fixing apparatus 4 includes a fixing film 42 in which a heater 41 is disposed, and a pressure roller 43 that forms a fixing nip with the heater 41 and transmits driving to the fixing film 42. The heater 41 heats the fixing film 42 at a fixing nip portion.

The fixing apparatus 4 includes a first thermistor 44a and a second thermistor 44b as temperature detection units that detect the temperature of the heater 41.

### Learning Data Collection

In the present embodiment, when a defect occurs in the image forming apparatus 110, feedback information in which fault component information that has caused the defect is associated with information indicating corrective action content for the fault component is collected as learning data based on a corrective action performed by the user.

Hereinafter, regarding an image anomaly included in image data as an example of a defect, learning data collection related to the image anomaly will be described.

In the present embodiment, the CPU 201 of the image forming apparatus 110 transmits a scanned image read by the scanner 202 to the apparatus defect information collection server 102 via the network 101. The CPU 221 of the fault diagnosis result notification server 104 can execute image diagnosis (inspection) processing of specifying type and position information of the image anomaly included in the scan image, a fault component candidate indicating the fault component that has caused the image anomaly, and a corrective action content candidate indicating the corrective action content for the fault component. The corrective action content for the fault component includes replacement, cleaning, adjustment, and repair of the fault component.

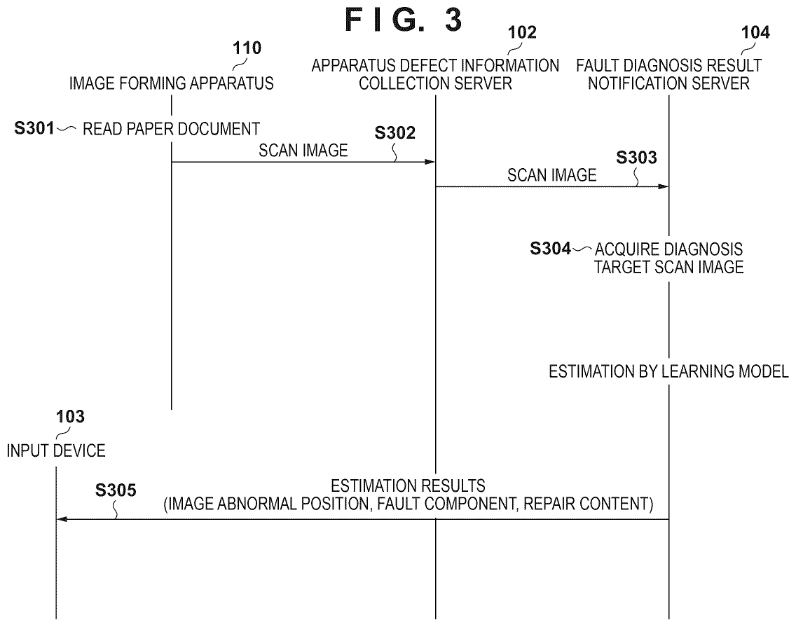

Hereinafter, an outline of the image diagnosis (inspection) processing executed in the present embodiment will be described. FIG. 3 is a sequence diagram related to the image diagnosis (inspection) processing indicated in the present embodiment. Hereinafter, the step number of each processing included in the sequence diagram is indicated by a number starting with “S”.

First, in S301, the CPU 201 reads a paper document by the scanner 202. The scanner 202 outputs, as a scan image 401, a real image on a paper document on which an image is printed by the image forming apparatus 110 or a printed test chart. For example, the operation panel 207 performs anomalous image reception for receiving a scanned image having an image anomaly. The operation panel 207 displays a message prompting to operate a start button after setting the paper document in the scanner 202. By this, the user sets a paper document on the scanner 202 and operates the start button of the operation panel 207. Note that normally, when the paper document has an image anomaly, anomalous image reception is used. It is assumed that the user scans a paper document having an image anomaly through anomalous image reception from the image forming apparatus 110.

In S302, the CPU 201 acquires the scan image 401 obtained by reading the paper document.

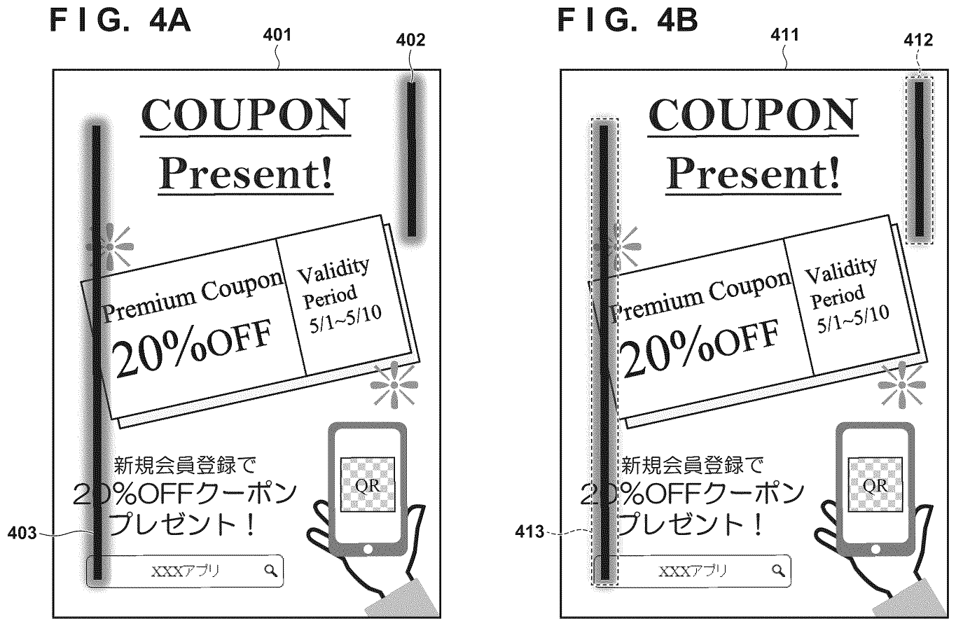

In S303, the CPU 201 transmits the scan image 401 and a time stamp (scan date and time information) to the apparatus defect information collection server 102. FIG. 4A is an example of the scan image 401 for describing an anomalous image according to the present embodiment. Image anomalies 402 and 403 are image anomalies included in the scan image 401.

In S304, the CPU 221 of the fault diagnosis result notification server 104 acquires the scan image 401 of the diagnosis target from the apparatus defect information collection server 102.

In S305, using a trained learning model, the CPU 221 of the fault diagnosis result notification server 104 estimates position information of the image anomaly included in the scan image 401, fault component information that has caused the image anomaly, and corrective action content for the fault component. That is, only by reading the paper document, the image forming apparatus 110 can estimate the position information of the image anomaly, the fault component, and the corrective action content. Here, machine learning may be executed using deep learning or other known object detection algorithms (object detection models).

In machine learning, an image including an image anomaly is learned as training data. An image including an image anomaly such as the scan image 401 transmitted as an image anomaly is visually observed by the maintenance person, and an anomalous portion is surrounded by a pointing device or the like to specify a region having an anomaly. Then, the type of image anomaly is indicated for each region having an anomaly. The types of image anomaly include a circular anomaly (dirt (point)) and a streak-like anomaly (dirt (streak)). In this manner, it is possible to create a learning model that specifies an anomalous portion from an image.

Specification of an anomalous portion can also be performed by image recognition processing. Specification of an anomalous portion can be performed by comparing the anomalous image with a normally printed image or a RIP image. When there is one anomaly region in the image, the user may simply designate the type of image anomaly. When there are a plurality of anomaly regions, the user selects the region and specifies the type of anomaly in each region.

FIG. 4B is an example of a diagnosis (inspection) image 411 for describing a result of executing the machine learning according to the present embodiment. The CPU 221 of the fault diagnosis result notification server 104 outputs a bounding box 412 indicating the image anomaly 402, an image anomaly type “image anomaly”, and a confidence. Since the scan image 401 includes a plurality of image anomalies, a bounding box 413 indicating the image anomaly 403, the image anomaly type “image anomaly”, and the confidence are output. The bounding boxes 412 and 413 include region information for specifying a region indicating an image anomaly that should be detected. For example, position information on an image anomaly and region information indicating the type of the image anomaly are included. The confidence is the likelihood of a detection result, and is indicated by a numerical value of 0 to 100, for example.

When the bounding box and the image anomaly type included in the diagnosis (inspection) image are erroneous, the user can correct them to give the learning model feedback learning. It is possible to increase the confidence of image diagnosis (inspection) by feeding back a correct answer in the case of a correct answer.

As the corrective action content corresponding to the anomalous image, data in which the type of the image anomaly and the content of the corrective action performed by the user such as the maintenance person are associated with each other is used as training data. The user selects a bounding box included in the anomalous image and inputs the content of the corrective action. When there is one anomalous portion included in the anomalous image, it is not necessary to select a bounding box. If the anomalous image and the corrective action performed to cancel the anomalous image are associated with each other, the anomaly type is identified, and the corrective action content corresponding to the anomaly type is specified.

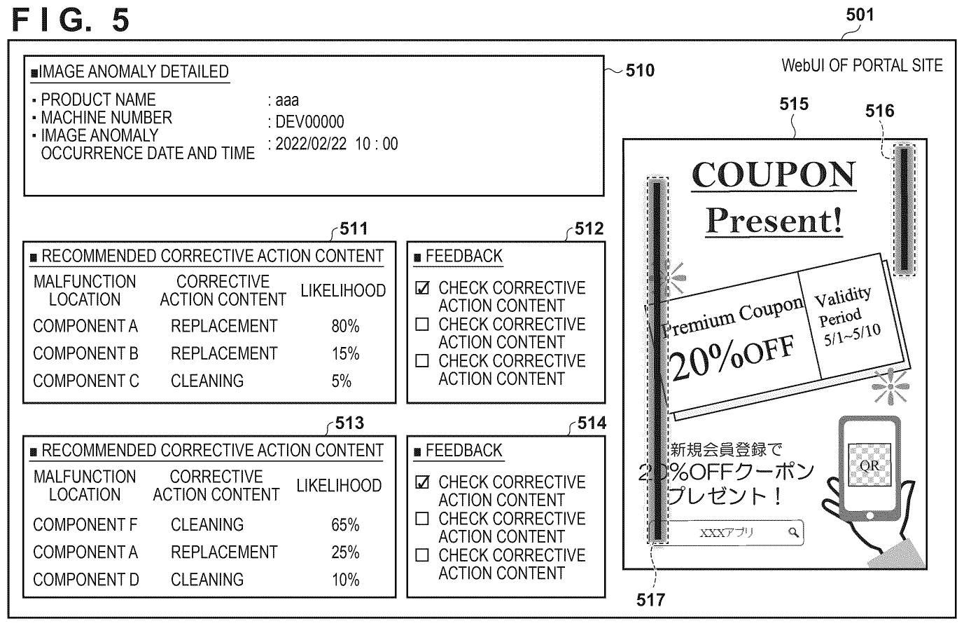

Display of the input device 103 will be described with reference to FIG. 5.

The display screen of the input device 103 displays a screen of a portal site 501. The portal site 501 is an example of a portal screen for inputting information to be transmitted to the fault diagnosis result notification server 104. The portal site 501 includes an image anomaly detailed information display portion 510 of a target, recommended corrective action content display portions 511 and 513, feedback input portions 512 and 514, a scan image display portion 515, and image anomaly position information display portions 516 and 517.

The input device 103 is a terminal used by the user. The input device 103 may be a tablet terminal or a smartphone that the maintenance person holds when performing maintenance of the image forming apparatus 106. By scanning a paper document having an image anomaly through anomalous image reception with the image forming apparatus 110 of a maintenance target, the user can confirm the image anomaly and the recommended corrective action content by the input device 103 that is a tablet terminal.

The image anomaly detailed information display portion 510 displays a product name, a machine number, and image anomaly occurrence date and time. The product name is a product type of the image forming apparatus 110. The machine number is a unique ID attached to each image forming apparatus 110. The image anomaly occurrence date and time is the date and time when the image anomaly occurred.

The recommended corrective action content display portion 511 or 513 displays a fault component candidate and a corrective action content candidate estimated to have a high possibility of resolving the event of the image anomaly in the fault diagnosis result notification server 104 for each image anomaly. When one scan image 401 includes a plurality of image anomalies, a fault component candidate and a corrective action content candidate are displayed for all the image anomalies. The recommended corrective action content may include replacement, cleaning, repair, and the like of a specific component. The display of the fault component candidate and the corrective action content candidate may include the likelihood that the processing resolves the event based on an estimation result.

In the example of the recommended corrective action content display portion 511, regarding the image abnormal position information display portion 516 of the scan image display portion 515, the likelihood of resolving the anomaly by replacing a component A is 80%, the likelihood thereof by replacing a component B is 15%, and the likelihood thereof by cleaning a component C is 5%.

The feedback input portion 512 is a screen for inputting feedback information. The corrective action content that has actually solved the anomalous phenomenon is input as feedback information. The input method may be a selection form such as a check box or a free input form with characters. When a plurality of image anomalies exist in one scan image 401, feedback information is input for all the image anomalies.

In the example of the feedback input portion 512, the component A displayed on the recommended corrective action content display portion 511 is replaced with respect to an image abnormal position information display portion 516 of the scan image display portion 515.

The scan image display portion 515 is a display portion that displays the scan image 401 transmitted from the user, and displays an anomaly region in a rectangular shape when there is an image anomaly. When a plurality of image anomalies exist in one scan image 401, a rectangle is displayed in the regions for all the image anomalies. The example of the scan image display portion 515 of FIG. 5 indicates existence of bounding boxes 516 and 517 in which an anomaly region included in the scan image display portion 515 is displayed in a rectangular shape.

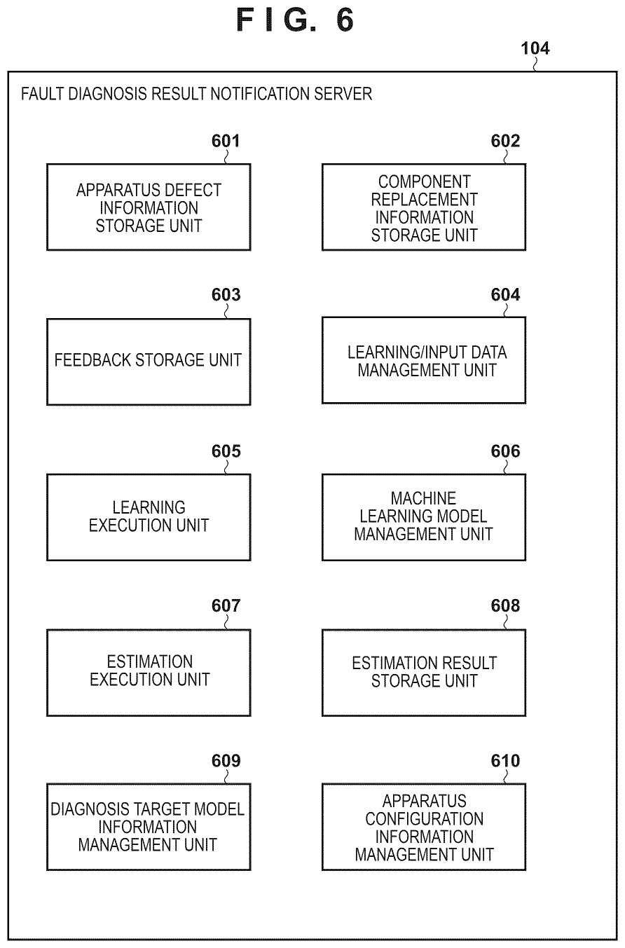

The software configuration of the fault diagnosis result notification server 104 of the present invention will be described with reference to FIG. 6. A program of the fault diagnosis result notification server 104 is read from the RAM 224, the storage apparatus 228, a secondary storage apparatus connected via the apparatus interface 229, and the like, and is implemented by being executed by the CPU 221 or the GPU 222 of the fault diagnosis result notification server 104. Access to the outside of the apparatus defect information collection server 102, the input device 103, and the like is performed via the network interface card 225.

The fault diagnosis result notification server 104 includes, as data storage units, an apparatus defect information storage unit 601, a component replacement information storage unit 602, and a feedback storage unit 603. The fault diagnosis result notification server 104 includes, as functional units of software, a learning/input data management unit 604, a learning execution unit 605, a machine learning model management unit 606, an estimation execution unit 607, and an estimation result storage unit 608.

The apparatus defect information storage unit 601 stores image anomaly information and the like of the image forming apparatus 110 received by the CPU 221 of the fault diagnosis result notification server 104 from the apparatus defect information collection server 102 via the network 101.

The component replacement information storage unit 602 stores replacement component information received by the CPU 221 of the fault diagnosis result notification server 104 from the replacement component information collection server 105 via the network 101.

The feedback storage unit 603 receives and stores, via the network 101, feedback information input by the CPU 221 of the fault diagnosis result notification server 104 through the feedback input portions 512 and 514 of the input device 103.

The learning/input data management unit 604 creates and stores learning data and input data based on each element information stored in the fault diagnosis result notification server 104. Each piece of element information includes the following information.
Fault information held in the apparatus defect information storage unit 601
Replacement component information held by the component replacement information storage unit 602
Feedback information held by the feedback storage unit 603

The learning/input data management unit 604 creates and stores learning data when the CPU 221 of the fault diagnosis result notification server 104 learns a machine learning model, and creates and stores input data when the CPU 221 of the fault diagnosis result notification server 104 performs estimation using the machine learning model.

In the learning execution unit 605, the CPU 221 of the fault diagnosis result notification server 104 acquires learning data from the learning/input data management unit 604, executes learning based on a machine learning algorithm designated in advance, and creates a machine learning model. The CPU 221 of the fault diagnosis result notification server 104 stores the created machine learning model into the machine learning model management unit 606. Note that the machine learning model may be recreated (retrained) by repeatedly executing learning in accordance with a change in the learning data stored in the learning/input data management unit 604.

The machine learning model management unit 606 stores the machine learning model that the CPU 221 of the fault diagnosis result notification server 104 created by the learning execution unit 605. Note that the machine learning model used for estimation may be replaced by using, as a trigger, reception of the machine learning model from the learning execution unit 605, condition determination in the machine learning model management unit 606, or the like. For example, when the correct answer rate of a new machine learning model exceeds a certain level, the new machine learning model may be replaced with the current machine learning model.

The estimation execution unit 607 executes estimation by the CPU 221 of the fault diagnosis result notification server 104 acquiring input data from the learning/input data management unit 604 and inputting the input data to the machine learning model stored in the machine learning model management unit 606.

The estimation result storage unit 608 stores the result of the estimation that the CPU 221 of the fault diagnosis result notification server 104 executed by the estimation execution unit 607. The estimation result storage unit 608 also transmits the estimation result to the input device 103 via the network 101. Alternatively, a request from the input device 103 may be received via the network 101, and an estimation result may be returned. The input device 103 displays the estimation result on the portal screen as illustrated in the recommended corrective action content display portions 511 and 513 and the scan image display portion 515. In the example of the bounding box 516 of the scan image display portion 515 and the recommended corrective action content display portion 511, in the recommended corrective action content of the bounding box 516, the likelihood of the component A is 80%, the likelihood of the component B is 15%, and the likelihood of the component C is 5%.

A diagnosis target model information management unit 609 stores a diagnosis target model series list 1110 of fault diagnosis targets for which the machine learning model is generated.

An apparatus configuration information management unit 610 stores an apparatus constituent component list 1101 related to each model of the fault diagnosis targets for which the machine learning model is generated.

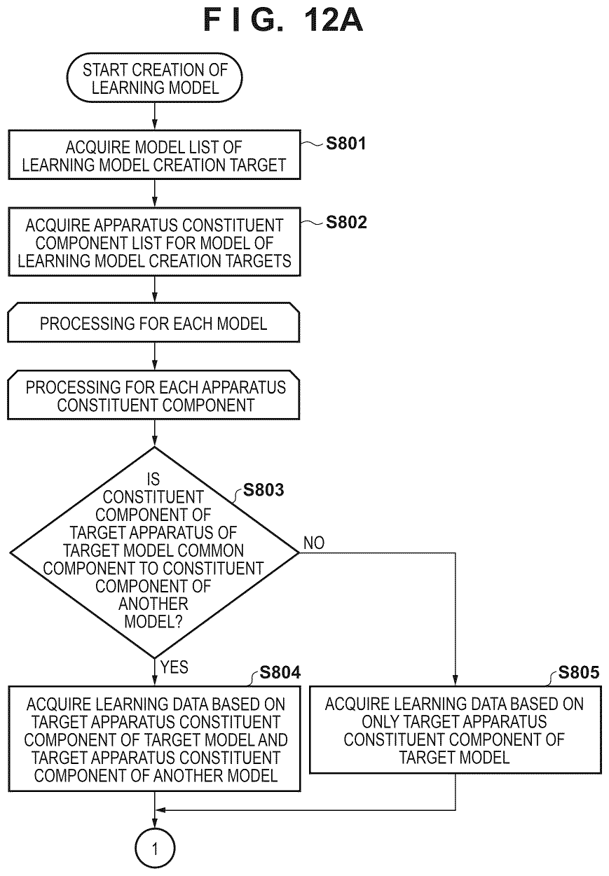

The diagnosis target model series list 1110 and the apparatus constituent component list 1101 will be described later in FIGS. 11A to 11C.

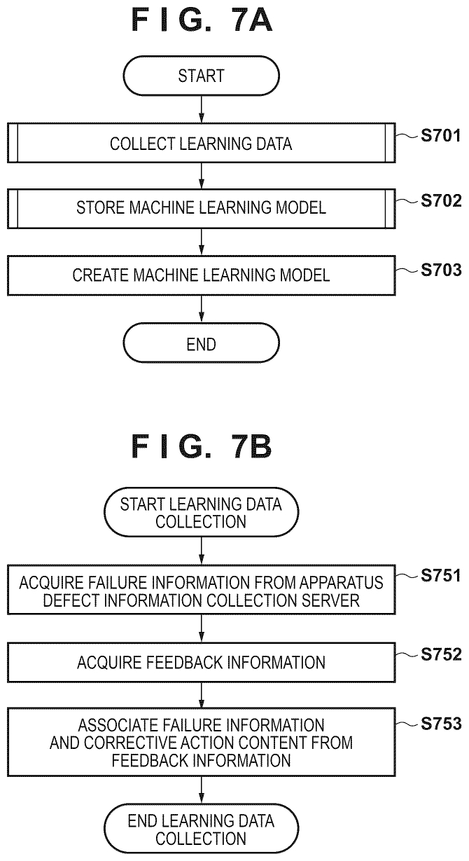

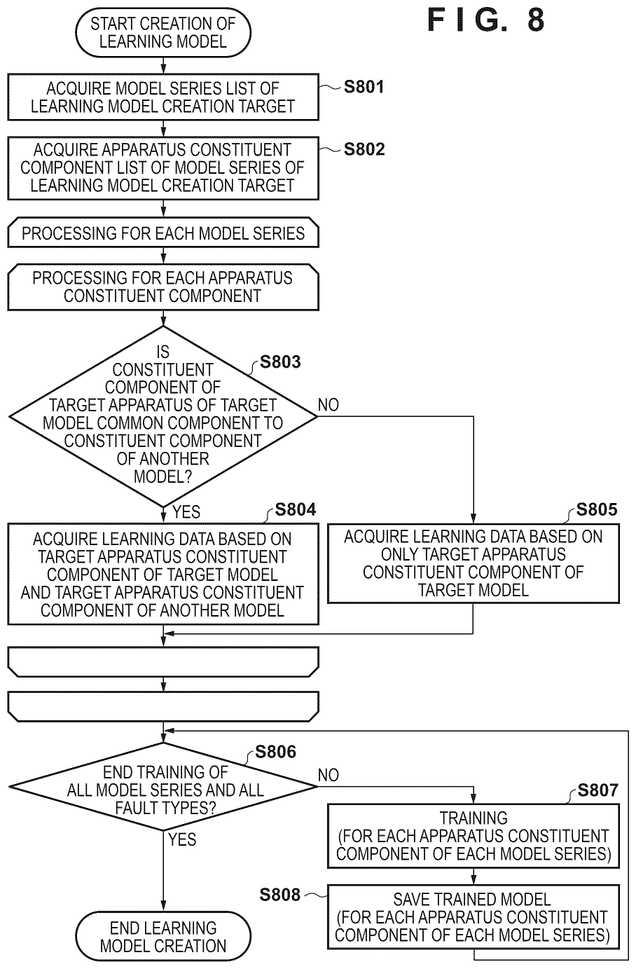

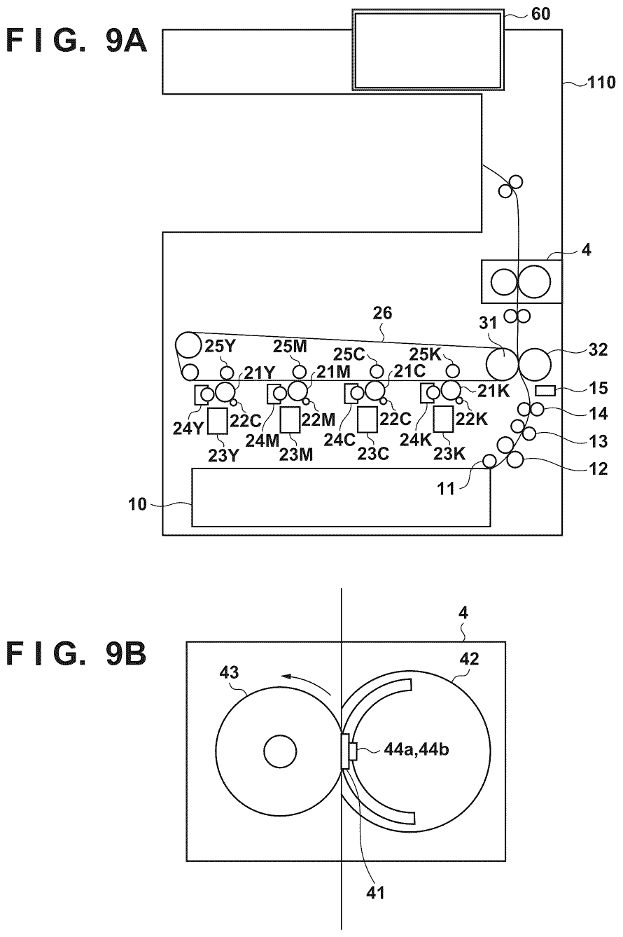

With reference to FIGS. 7A and 7B and FIG. 8, a proposed technique shown in the present embodiment will be described.

FIG. 7A is an overall flowchart of the fault diagnosis result notification server 104 in the present embodiment. The processing of FIGS. 7A and 7B and FIG. 8 is implemented, for example, by the CPU 221 or the GPU 22 of the fault diagnosis result notification server 104 reading a program stored in the ROM 223 or the external memory 226 into the RAM 224 and executing the program. Hereinafter, the step number of each process included in the flowchart is indicated by a number starting with “S”. The same applies to the subsequent flowcharts.

First, in S701, the CPU 221 of the fault diagnosis result notification server 104 collects learning data by the learning/input data management unit 604. Next, in S702, the CPU 221 of the fault diagnosis result notification server 104 creates a machine learning model by the learning execution unit 605 using the collected learning data. Finally, in S703, the CPU 221 of the fault diagnosis result notification server 104 stores the created machine learning model into the machine learning model management unit 606.

In the image forming apparatus 110, when an image anomaly occurs, the fault diagnosis result notification server 104 receives a notification from the image forming apparatus 110. The CPU 221 of the fault diagnosis result notification server 104 estimates the corrective action content by the estimation execution unit 607 using the machine learning model created in the flow of FIG. 7A. The CPU 221 of the fault diagnosis result notification server 104 transmits the estimation result to the input device 103. The portal site 501 is displayed on the input device 103, and the user can confirm the portal site 501. The user can input feedback information via the portal site 501 displayed on the input device 103. For example, the portal site 501 receives inputs of feedback information 512 for the bounding box 516 and feedback information 514 for the bounding box 517. The CPU 221 of the fault diagnosis result notification server 104 saves, into the feedback storage unit 603, the received feedback information 512 and 514.

FIG. 7B is a flowchart showing details of the learning data collection of the fault diagnosis result notification server 104 in the present embodiment of S701 of FIG. 7A.

In S751, the CPU 221 of the fault diagnosis result notification server 104 acquires image anomaly information from the image anomaly information collection server 102 and stores it into an image anomaly information storage unit 701. An example of image anomaly information collected by the image anomaly information collection server 102 is shown in Table 1. The product name is a product type of the image forming apparatus 110. The machine number is a unique ID for specifying each image forming apparatus 110. The scan image transmission date and time is the date and time when the user transmitted the scan image. The scan image ID is a unique ID attached to each transmitted scan image. The image anomaly ID is a unique character string code for recognizing an image anomaly included in the transmitted scan image.

For example, the first line of Table 1 has a meaning that “Regarding the machine number DEV0001 of the product name PRO1001, the user transmitted the scan image ID SCA0001, 2022 Feb. 1 10:00. The image anomaly ID is IMA1001.”

TABLE 1
IMAGE ANOMALY INFORMATION

| | | SCAN IMAGE | | |
|---|---|---|---|---|
| | | TRANSMISSION | SCAN | IMAGE |
| PRODUCT | MACHINE | DATE AND | IMAGE | ANOMALY |
| NAME | NUMBER | TIME | ID | ID |
| PRO1001 | DEV0001 | 2022 Feb. 1 10:00 | SCA0001 | IMA1001 |
| PRO1001 | DEV0001 | 2022 Feb. 1 10:00 | SCA0001 | IMA1002 |

An example of bounding box information for the image anomaly is shown in Table 2. The scan image ID is a unique ID attached to each transmitted scan image. The image anomaly ID is a unique character string code for recognizing an image anomaly included in the transmitted scan image. The X coordinate and the Y coordinate are vertex coordinates (pixel values) at the upper left of the bounding box, and the height and the width are the height and the width (pixel values) of the bounding box. In the example of Table 2, there are two image anomalies in the image data of the scan image ID “SCA0001”, and two pieces of bounding box information corresponding to the two image anomalies are included.

TABLE 2
BOUNDING BOX INFORMATION

| SCAN | IMAGE | X | Y | | |
|---|---|---|---|---|---|
| IMAGE | ANOMALY | COORDI- | COORDI- | | |
| ID | ID | NATE | NATE | HEIGHT | WIDTH |
| SCA0001 | IMA1001 | 100 | 150 | 50 | 30 |
| SCA0001 | IMA1002 | 200 | 500 | 60 | 30 |

Next, in S752, the CPU 221 of the fault diagnosis result notification server 104 acquires feedback information of the machine number from the feedback storage unit 603. An example of the feedback information is shown in Table 3.

The product name is a product type of the image forming apparatus 110. The machine number is a unique ID attached to each image forming apparatus 110. The corrective action date and time is the date and time when the user performed corrective action. The scan image ID is a unique ID attached to each transmitted scan image. The image anomaly ID is a unique character string code for recognizing an image anomaly included in the transmitted scan image. The corrective action content is the name of the corrective action content actually performed by the user. The fault component is the name of a component actually repaired or replaced by the user.

For example, the first line of Table 3 has a meaning that “Regarding the machine number DEV0001 of the product name PRO1001, the component A was replaced for the image anomaly ID IMA1001 on the scan image ID SCA0001, 2022 Feb. 3 14:02”.

TABLE 3
FEEDBACK INFORMATION

| | | CORRECTIVE | | | | |
|---|---|---|---|---|---|---|
| | | ACTION | | IMAGE | CORRECTIVE | |
| PRODUCT | MACHINE | DATE AND | SCAN | ANOMALY | ACTION | FAULT |
| NAME | NUMBER | TIME | IMAGE ID | ID | CONTENT | COMPONENT |
| SCA0001 | DEV0001 | Mar. 2, 2022 | SCA0001 | IMA1001 | REPLACEMENT | COMPONENT A |
| | | 14:02 | | | | |
| SCA0001 | DEV0001 | Mar. 2, 2022 | SCA0001 | IMA1002 | CLEANING | COMPONENT F |
| | | 14:02 | | | | |

In S753, the CPU 221 of the fault diagnosis result notification server 104 associates the scan image ID, the image anomaly ID, the fault component, and the corrective action content from the feedback information in the feedback storage unit 404. Table 4 shows data of corrective action for the fault that is a result of associating the scan image ID, the image anomaly ID, the fault component, and the corrective action content from the feedback information.

The product name in the data of corrective action for the fault in Table 4 is the product type of the image forming apparatus 110. The scan image ID is a unique ID attached to each transmitted scan image. The image anomaly ID is a unique character string code for recognizing an image anomaly of the transmitted scan image. The X coordinate and the Y coordinate are vertex coordinates (pixel values) at the upper left of the bounding box, and the height and the width are the height and the width (pixel values) of the bounding box. The corrective action content is the name of the corrective action content actually performed by the user. The fault component is the name of a component actually repaired or replaced by the user.

TABLE 4
LEARNING DATA ASSOCIATED WITH POSITION INFORMATION, CORRECTIVE
ACTION CONTENT, AND FAULT COMPONENT FOR IMAGE ANOMALY

| | | IMAGE | X | Y | | | CORRECTIVE | |
|---|---|---|---|---|---|---|---|---|
| PRODUCT | SCAN | ANOMALY | COORDI- | COORDI- | | | ACTION | FAULT |
| NAME | IMAGE ID | ID | NATE | NATE | HEIGHT | WIDTH | CONTENT | COMPONENT |
| PRO1001 | SCA0001 | IMA1001 | 100 | 150 | 50 | 30 | REPLACEMENT | COMPONENT A |
| PRO1001 | SCA0001 | IMA1002 | 200 | 500 | 60 | 30 | CLEANING | COMPONENT F |

Table 4 enables association of the image anomaly occurred in the image forming apparatus 110, the corrective action content performed to resolve the image anomaly, and the fault component. This can provide a mechanism for using, as learning data, the data of corrective action for the fault including information on the corrective action performed by the user, for the type of fault of the apparatus (type of image anomaly of the image forming apparatus).

FIG. 8 is a flowchart showing an example of a creation step of the machine learning model of the fault diagnosis result notification server 104 in the present embodiment corresponding to S702 of FIG. 7A.

In S801, the CPU 221 of the fault diagnosis result notification server 104 acquires a model series list of learning model creation targets based on the diagnosis target model series list 1110 stored in the diagnosis target model information management unit 609. FIG. 11C is an example of the diagnosis target model series list 1110. The model series is a model number of the image forming apparatus 110. A diagnosis target FLG indicates whether or not to be a diagnosis target model series. If the diagnosis target FLG is “1”, it is a diagnosis target, and if “0”, it is a non-diagnosis target.

In S802, the CPU 221 of the fault diagnosis result notification server 104 acquires the apparatus constituent component list 1101 for the model of the learning model creation targets stored in the apparatus configuration information management unit 610.

FIG. 11A is an example of the apparatus constituent component list 1101. The component name is an apparatus constituent component constituting the image forming apparatus 110. The model series is a model number of the image forming apparatus 110. For example, parts_A001 described in the component A of a model series A represents the type of the component A. That is, the component A includes components of the type of parts_A001, a component F includes components of the type of parts_F001, and a component Q includes components of the type of parts_Q002. Here, the component A, the component F, the component Q, and a component Y correspond to components constituting the image forming apparatus 110, and correspond to, for example, the photosensitive drum 14, the intermediate transfer belt 26, the fixing apparatus 4, and the like described in FIG. 9A.

FIG. 11B shows, with a common component 1112, a common component determination result with components of another model series regarding the model series A of the apparatus constituent component list 1101. For example, the component A in the apparatus constituent component list 1101 has a meaning that “The model series A includes components of the type of parts_A001, the model series B includes components of the type of parts_A002, and the model series C includes components of the type of parts_A003”. That is, the component A is not a common component in the model series A, B, and C. Part F has a meaning that “The model series A includes components of the type of parts_F001, the model series B includes components of the type of parts_F001, the model series C includes components of the type of parts_F002, the model series D includes components of the type of parts_F002, and the model series E includes components of the type of parts_F002”. That is, the component F is the common component parts_F001 in the model series A, B, and E, but is not a common component with the model series C and D. On the other hand, in the model series C and D, the component F is the common component parts_F002.

In S803 to S805, the CPU 221 of the fault diagnosis result notification server 104 performs processing for each apparatus constituent component for each model based on the information acquired in S801 and S802.

In S803, the CPU 221 of the fault diagnosis result notification server 104 determines whether or not each apparatus constituent component is common for each model series based on the apparatus constituent component list 1101.

For example, if it is determined in S803 that the apparatus constituent components of the first model and the second model are common components (Yes), the process proceeds to S804. Then, in S804, the CPU 221 of the fault diagnosis result notification server 104 acquires fault information caused by the model constituent component of the first model and fault information caused by the common component of the second model held in the apparatus defect information storage unit 601. Then, the acquired fault information caused by the model constituent component of the first model and fault information caused by the common component of the second model are set as learning data of the first model. Thus, the fault information caused by the common component is acquired as learning data of the learning model of the apparatus constituent component of the first model for all the other models having the common components. As the learning data, fault information held by the apparatus defect information storage unit 601, replacement component information held by the component replacement information storage unit 602, and data of corrective action for the fault derived from Table 4 are acquired. Any one of the replacement component information and the data of corrective action for the fault derived from Table 4 may be used.

For example, if it is determined in S803 that the apparatus constituent components of the first model and the second model are not common components (No), the process proceeds to S805. Then, in S805, the CPU 221 of the fault diagnosis result notification server 104 acquires, as learning data, only fault information caused by the apparatus constituent component collected from the first model held by the apparatus defect information storage unit 601 for training the learning model of the first model. As the learning data, fault information held by the apparatus defect information storage unit 601, replacement component information held by the component replacement information storage unit 602, and data of corrective action for the fault derived from Table 4 are acquired. Any one of the replacement component information and the data of corrective action for the fault derived from Table 4 may be used. The fault information caused by the apparatus constituent component not common to the second model is not used as the learning data of the learning model of the first model. For other models, fault information of an apparatus constituent component of a model that does not constitute a common component with the first model is not used as learning data of the learning model of the first model.

In S806 to S808, the CPU 221 of the fault diagnosis result notification server 104 performs training of the learning model for each fault type for each model series using the learning data generated in S803 to S805. In S806, it is determined whether training of learning models of all model series and all fault types has been performed. If the training of the learning models of all the model series and all the fault types is not ended (No), the process proceeds to S807. If the training of the learning models of all the model series and all the fault types is ended (Yes), the flow ends. The training of the learning models in S807 and S808 is repeated until the training of the learning models of all the model series and all the fault types is ended.

In the present embodiment, training of the learning model is performed for each model series and each fault type, but training of the learning model may be performed for a plurality of fault types collectively for each model series. A learning model for each model series or for each fault component may be created. In the present embodiment, the fault information caused by the common component collected from the first model and the fault information caused by the common component collected from another (second) model are acquired as the learning data of the learning model of the first model, and training is performed. If it is determined that the components of the first model and the second model are common components, the flow of FIG. 8 can be changed so that the learning data collected from the first model is used as the learning data of the learning models of the first and other (second) models. In this case, it is similar that if it is determined that the component of the first model and the component of the other (second) model are non-common components, the fault information of the first model is used only as the learning data of the learning model of the first model and is not used as the learning data of the learning model of the other (second) model.

In S807, using an object detection algorithm, the CPU 221 of the fault diagnosis result notification server 104 performs training of the learning model for each fault type (anomaly type of image) for each model series generated in S804 and S805. As the object detection algorithm, an algorithm called a known detection transformer (DETR) can be used. For example, a bounding box that is a frame including an object is estimated using a convolutional neural network. Then, the confidence that the bounding box includes an object and the probability for each type of object when the bounding box includes an object are predicted. In learning, a learning result is evaluated by cross verification in which learning data is randomly divided into analysis data and verification data. This can create a learning model for estimating the diagnosis (inspection) image 411 of FIG. 4B.

Here, the machine learning algorithm has various methods. Various object detection models can be used to detect a rectangular region indicating an image (e.g., image anomaly) of a focused target object. For example, there are You Only Look Once (YOLO), Single Shot MultiBox Detector (SSD), Region Based Convolutional Neural Networks (R-CNN), and the like. Hyperparameters of the machine learning algorithm also vary depending on the machine learning algorithm. In the present embodiment, the machine learning algorithm, the evaluation technique of the learning result, the optimization method of the hyperparameters of the machine learning algorithm, and the like can be appropriately changed.

With the image forming apparatus as an example, in machine learning, training is performed to associate an anomaly type (type of fault of the apparatus) of the diagnosis (inspection) image with a component that has caused the anomaly and corrective action content performed to resolve the anomaly. In the above description, the data of corrective action for the fault derived from Table 4 is used as the learning data. However, in the initial state in which the feedback information of Table 3 is not accumulated, it is necessary for the user to create data of corrective action for the fault in which the anomaly type (type of fault of the apparatus) of the diagnosis (inspection) image, the component that has caused the anomaly, and the corrective action contents for resolving the anomaly are associated with one another. Then, the created data of corrective action for the fault is used as learning data.

Creation of the data of corrective action for the fault by the user will be described.

The user specifies the anomaly type (type of fault of the apparatus) and the anomalous portion in the scan image including the anomaly, and associates the fault component with the corrective action content for the anomaly type. If there is one anomalous portion in the scan image, it is possible to automatically associate the fault component and the corrective action content or the replacement component information with respect to the anomaly type.

If there are a plurality of anomalous portions in the scan image, the anomaly types may be different. There is a case where a difference in anomaly type causes a difference in components causing the difference, and a plurality of fault components or replacement components may correspond to one scan image. In such a case, the user creates data of corrective action for the fault by associating the fault component and the corrective action content or the replacement component information with the region of the anomalous image of the scan image while confirming the scan image. Then, the created data of corrective action for the fault is used as learning data for creating a learning model.

In S808, the CPU 221 of the fault diagnosis result notification server 104 saves the trained model trained in S807 into a file and registers it into the machine learning model management unit 606.

Here, the file saving the trained model includes the type of the learning algorithm and the value of the hyperparameter of the learning algorithm.

As described above, when it is determined that the constituent component matching the fault component information included in the learning data collected from the first model is the component common to the constituent component of the second model, the learning data collected from the first model and the second model are used as the learning data of the first model. This can provide a mechanism of selecting learning data collected based on apparatus configuration information and efficiently using the collected learning data.

### Second Embodiment

In the First Embodiment, the trained model was generated using, as the learning data of the first model, the fault information of the first model and another model having a common component as the constituent component. The trained model generated in the First Embodiment is a trained model LM1.

However, when the diagnostic accuracy of the trained model LM1 is compared with the diagnostic accuracy of a trained model LM2 in which a trained model is generated using the learning data of only the first image forming apparatus, the accuracy of the trained model LM1 is not necessarily good. In the First Embodiment, the trained model LM1 is a trained model generated with emphasis on collecting learning data from more models. Therefore, even if a common component is used, fault information of a model having a different structure is also used as the learning data, and therefore the diagnosis accuracy of the trained model LM1 may be lower than that of the trained model LM2 trained with fault data of only one model.

In the present embodiment, the diagnosis accuracies of the trained model LM1 and the trained model LM2 will be focused.

In the present embodiment, the trained model LM1 and the trained model LM2 in the First Embodiment are compared, and the trained model having higher diagnosis accuracy is selected and adopted.

A machine learning system configuration diagram (FIG. 1), a hardware configuration diagram (FIGS. 2A and 2B), an input terminal screen example diagram (FIG. 5), a software configuration diagram (FIG. 6), and a configuration of the image forming apparatus 110 (FIGS. 9A and 9B) of the present embodiment are similar to those of the First Embodiment, and therefore description thereof will be omitted. Since a flowchart (FIG. 3) for specifying a corresponding candidate, a learning data collection processing flow (FIGS. 7A and 7B), and an apparatus constituent component list (FIGS. 11A to 11C) are also similar to those in the First Embodiment, the description thereof will be omitted.

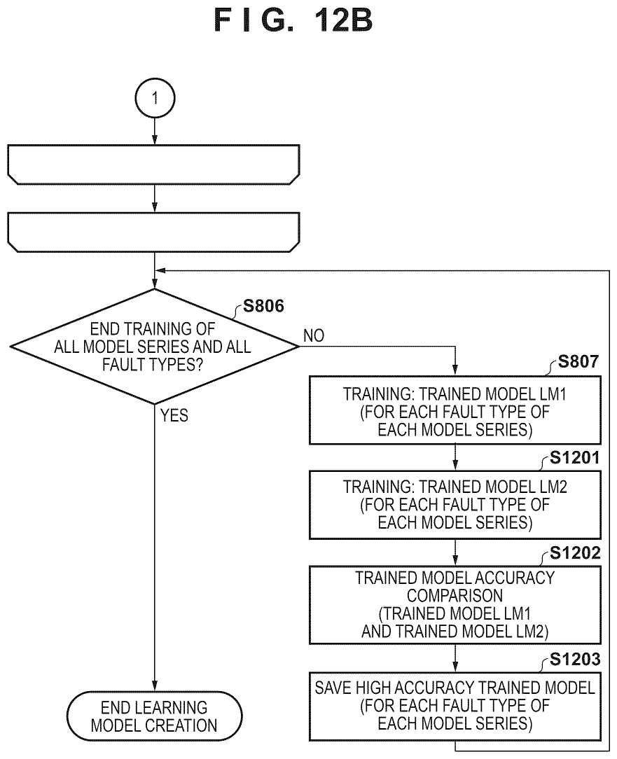

FIGS. 12A and 12B together form a single flowchart showing details of learning data collection processing S702 of the fault diagnosis result notification server 104 in the Second Embodiment.

Since S801 to S807 overlap with the content shown in FIG. 7B, the description thereof will be omitted.

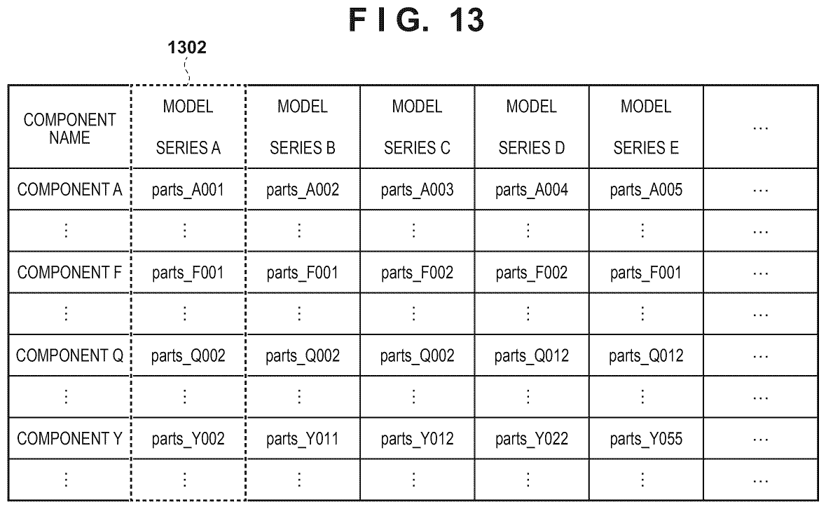

In S1201, the CPU 221 of the fault diagnosis result notification server 104 generates the trained model LM2 of the first model using the fault information of only the first model as the learning data not taking the common component into consideration. In the trained model LM2, fault information of another model having a common component with the first model is not used as learning data. FIG. 13 shows an acquisition target 1302 of learning data acquired for training the trained model LM2 of the model series A of the apparatus constituent component list 1101. The trained model LM1 is a trained model generated by training the model series A by using learning data acquired by targeting 1112 of FIG. 11B.

In S1202, the CPU 221 of the fault diagnosis result notification server 104 compares the diagnosis accuracy of the trained model LM1 generated in S807 with the diagnosis accuracy of the trained model LM2 generated in S1201. In the flow of FIG. 12A and 12B, the learning result is evaluated by cross verification in which learning data is randomly divided into analysis data and verification data. The trained models LM1 and LM2 are generated by the analysis data, and in S1202, the trained models LM1 and LM2 are verified using the verification data, and verification is performed depending on whether a correct answer is obtained.

In S1203, the CPU 221 of the fault diagnosis result notification server 104 saves, into a file, the trained model with high diagnosis accuracy verified in S1202 and registers it into the machine learning model management unit 606. In S1203, both the trained models LM1 and LM2 may be registered, and it may be possible to select which model of LM1 and LM2 to use.

As described above, by comparing the diagnosis accuracies of the trained model LM1 and the trained model by verification and adopting the one with a better verification result, it is possible to perform more accurate fault diagnosis. The corrective action content may be inferred using both the trained models LM1 and LM2, and the confidence may be determined according to the accuracy of the verification result.

The number of pieces of learning data to be collected may be provided with a threshold, and the corrective action content may be estimated using the trained model LM1 when the number of learning data is smaller than the threshold, and the corrective action content may be estimated using the trained model LM2 when the number of learning data is equal to or greater than the threshold. In this way, a highly accurate trained model can be generated by performing training by collecting a large amount of learning data from the model using the common component when the fault information is small, and acquiring the learning data only from the fault information of the corresponding model when the fault information is accumulated.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-041590, filed Mar. 15, 2024 which is hereby incorporated by reference herein in its entirety.

What is claimed is:

1. A machine learning system for training a learning model, comprising:
a processor configured to execute a training algorithm using training data;
a memory storing data of corrective action for a fault and a learning model, wherein the data of corrective action for the fault includes a type of fault for each type of apparatus, a constituent component of the apparatus that has caused the fault, and corrective action content for the fault, and
a training unit configured to perform training of the learning model for estimating corrective action content from a type of fault for each type of the apparatus based on the data of corrective action for the fault,
wherein the training unit is configured to
perform training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.

2. The machine learning system according to claim 1, further comprising:
an estimation unit configured to predict the corrective action for a fault of the apparatus based on the learning model, and
a reception unit configured to receive a corrective action performed by a user from a candidate of the estimated corrective action and cause the memory to store the corrective action as data of corrective action for the fault.

3. The machine learning system according to claim 2, further comprising a unit configured to transmit the candidate of the estimated corrective action to an input device,
wherein the reception unit receives a corrective action performed by the user from the input device.

4. The machine learning system according to claim 1, wherein
the apparatus is an image forming apparatus, and
the fault is an image anomaly included in image data on which an image is formed.

5. The machine learning system according to claim 1, wherein,
the training unit is configured to perform training of a first learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type, and perform training of a second learning model for estimating the corrective action content from the type of fault for an apparatus of a first type using, as learning data, the data of corrective action for the fault of the apparatus of the first type, and not using the data of corrective action for the fault related to the common constituent component of the apparatus of the type different from the apparatus of the first type, and
compare the first learning model and the second learning model and select a model with high diagnosis accuracy.

6. A machine learning method, the method comprising:
providing data of corrective action for a fault, wherein the data of corrective action for the fault includes a type of fault for each type of apparatus, a constituent component of the apparatus that has caused the fault, and corrective action content for the fault; and
performing training of the learning model for estimating corrective action content from a type of fault for each type of the apparatus based on the data of corrective action for the fault,
wherein the training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.

7. A non-transitory computer-readable storage medium storing data of corrective action for a fault, one or more learning models, and one or more programs, wherein the data of corrective action for the fault includes a type of fault for each type of apparatus, a constituent component of the apparatus that has caused the fault, and corrective action content for the fault,
the programs are configured to cause a computer to execute each step of a machine learning method, the method comprising:
performing training of the learning model for estimating corrective action content from a type of fault for each type of the apparatus based on the data of corrective action for the fault,
wherein the training of the learning model for estimating the corrective action content from the type of fault for an apparatus of a first type using, as learning data, data of corrective action for the fault of the apparatus of the first type, and data of corrective action for the fault related to a common constituent component of an apparatus of a type different from the apparatus of the first type having the common constituent component to a fault component that has caused the fault of the apparatus included in the data of corrective action for the fault of the apparatus of the first type.
